(19) United States
(12) Patent Application Publication
(10) Pub. No.: US 2004/0179262 A1
(43) Pub. Date: Sep. 16, 2004

(54) Open GL

(75) Inventors: Philip Victor Harman, Scarborough (AU); Julien Charles Flack, Swanbourne (GB); Hugh Ross Sanderson, Shenton Park (AU)

Correspondence Address: BANNER & WITCOFF, 1001 G STREET N W, SUITE 1100, WASHINGTON, DC, 20001, US

(73) Assignee: Dynamic Digital Depth Research Pty Ltd, Bentley (AU)

(21) Appl. No.: 10/720,687

(22) Filed: Nov. 25, 2003

(30) Foreign Application Priority Data
Nov. 25, 2002 (AU) 2002952872

(51) Int. Cl. G02B 27/22

(52) U.S. Cl. 359/462

(57) ABSTRACT

A method of generating images suitable for use with a multi-view stereoscopic display including the steps of intercepting data passed from an application to an application programming interface, the data representing a scene or object to be displayed on the display; processing the data to render multiple views of the scene or object; creating modified data by modifying the intercepted data to represent the multiple views; and passing the modified data to the application programming interface.

### FIELD OF THE INVENTION

The present invention is directed towards an improved technique for the generation of images for use with autostereoscopic displays. In particular the present invention relates to a method of automatically producing images derived from computer generated source images.

### BACKGROUND OF THE INVENTION

A number of autostereoscopic displays are starting appear on the market.

Whilst some of these displays require a conventional stereoscopic pair of images others require multiple images in order to provide an autostereoscopic image. Such multiple image displays enable the viewer to retain stereoscopic effect despite movement of their head.

Such displays generally require images comprising a number of views created from a number of laterally displaced cameras. Such views can be originated from real cameras or generated using computer graphic techniques.

In U.S. Pat. Nos. 6,118,584 and 6,064,424, included here in full by reference, van Berkel describes an autostereoscopic display that requires seven views. In German patent PCT WO 01/56302 A1, included here in full by reference, Grasnik describes an autostereoscopic display that requires eight views.

Such displays are known to require multi-views or integer multi-views in order to display autostereoscopic images.

Given the commercial availability of such multi-view displays there is a corresponding requirement for suitable images or content. Whilst such content can be obtained from a number of laterally displaced cameras this invention relates to the generation of images using computer graphic techniques.

Computer graphic 3D models can be created and 2D views generated. A 2D view can be characterised by the location of a virtual camera. The x, y and z location of the virtual camera defines the resulting 2D image. Those skilled in the art will be familiar with computer graphic software packages that provide such a capability and 3D Studio Max by Discrete Inc. is an example of such a package.

The prior art also teaches that stereoscopic images, i.e. independent left and right eye images may be rendered from a computer graphic 3D model. This is achieved by rendering one image and then laterally displacing the virtual camera to produce a second image. Those skilled in the art will appreciate that the stereoscopic effect so produced is a function of the separation and toe-in of such virtual cameras.

As noted above in order to be commercially successful multi-view autostereoscopic displays require to be supported with suitable content. It is desirable that such content be produced inexpensively and in large quantities.

Whilst it is possible to create original content for such displays using a number of laterally displaced video cameras it has been found in practice that such configurations are impractical. An alternative is to create images using computer graphic techniques and the prior art teaches how existing 3D graphics software, using multiple virtual cameras, can provide suitable images at low cost and complexity.

In order to support multi-view screens it would therefore appear obvious to simply render multiple lateral views, one for each virtual camera location. This technique was proposed by van Berkel in a paper “Image Preparation for 3D-LCD” presented at the IS&T/SPIE Conference on Stereoscopic Displays and Applications X, San Jose, Calif., January 1999.

In this paper van Berkel proposes that image preparation is best undertaken at the graphics API (application programming interface) level and gives an example using the OpenGL API.

Many existing graphics applications use an API in order to generalise the generation of computer images. Those skilled in the art will be familiar with OpenGL, DirectX, Direct3D and Starbase API's.

Such graphics applications include, although are not limited to, games, simulations, architectural design, modelling and molecular design.

If access to the source code of such applications is available then it is possible to modify the code so as to produce an image suitable for directly displaying on a multi-view autostereoscopic display.

Such a technique is described in the document ‘4D-Vision Programming Manual’ available from 4D-Vision, GmbH, Jena, Germany.

Such a process is non trivial and requires the close co-operation of the owners of the original source code. As such it is expected that in practice only a limited range of applications will be available for modification for use on a multi-view display.

It is known to those skilled in the art that personal computer graphics cards require software drivers in order to correctly interpret an applications graphics commands and convert them into images. In general, each particular brand, make and model of graphics card requires a custom written software driver. It will be appreciated to those skilled in the art that it would be possible to modify the source code of the driver so as to produce an image suitable for directly displaying on a multi-view autostereoscopic display.

Such a process has been demonstrated by 4D-Vision GmbH in the production of a DirectX driver, for their range of autostereoscopic screens.

It will be appreciated that in order to address the widest market possible then it is desirable that a large number of graphics cards are available to support the multi-view function. The modification of such drivers is non trivial and requires the close co-operation of the owners of the original source code. As such it is expected that in practice only a limited range of graphics cards will be available for modification for use with a multi-view display.

The current invention discloses a more efficient technique for developing images for multi-view autostereoscopic displays as well as a technique for improving the quality of images displayed.

### OBJECT OF THE INVENTION

It is therefore an object of the present invention to provide an improved method for the real time generation of images, from computer graphic sources, suitable for use with multi-view autostereoscopic displays, and for improving the quality of such images.

### SUMMARY OF THE INVENTION

With the above object in mind the present invention provides in one aspect a system for creating images suitable for use with a multi-view autostereoscopic display including:

a capture means for intercepting 3D geometric primitives and associated characteristics passed between an application and an application programming interface;

a view generation means for imaging said 3D geometric primitives and said associated characteristics from multiple distinct viewing positions'

a mask calculation means for determining a relative contribution of each view based on characteristics of an associated lenticular lens array; and

an accumulation means for combining said views with said masks to generate a composite 3D image.

In the preferred arrangement the data is intercepted by searching directories for an application programming interface function; and inserting a modified function into the directories to intercept the data intended for the application programming interface function. Alternatively, the data may be intercepted by looking up an internal symbol table to determine a memory location for an application program interface function; storing a modified library into memory; and redirecting application commands to the memory location to the modified library

In a further aspect the present invention provides a method of generating images suitable for use with a multi-view stereoscopic display including the steps of:

intercepting data passed from an application to an application programming interface, said data representing a scene or object to be displayed on said display, and wherein said data is intercepted by looking up an internal symbol table to determine a memory location for an application programme interface function, storing a modified library into memory, and redirecting application commands to said memory location to said modified library;

processing said data to render multiple views of said scene or object;

creating modified data by modifying said intercepted data to represent said multiple views;

passing said modified data to said application programming interface.

### BRIEF DESCRIPTION OF THE DRAWINGS

FIG. 1 illustrates how a computer graphic program calls an API.

FIG. 2 illustrates the principle of the present invention.

FIG. 3 illustrates the principle of a slanted lenticular 3D-LCD following van Berkel.

### DETAILED DESCRIPTION OF THE INVENTION

The present invention discloses a technique where images suitable for display on a multi-view autostereoscopic screen can be generated without the need to modify either the original graphics application or the graphics card driver.

In effect the present invention discloses a method whereby data being transferred from an application to an API is intercepted and modified, before allowing the data to proceed to the API. This is in contrast to existing teachings which modify the data received by the API, or later at the display driver.

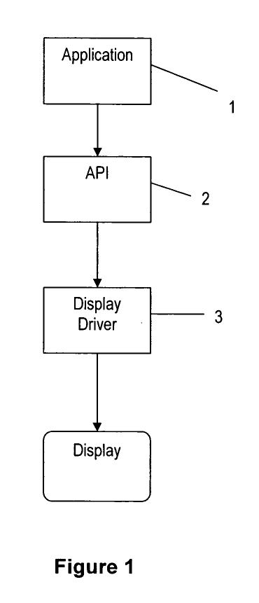

The basic principle behind the invention is shown in FIG. 1. Here a software application 1, communicates with an API 2 to a display driver 3. For purposes of explanation only the OpenGL API will be used, however, those skilled in the art will appreciate that the invention can be applied to other graphics API's.

OpenGL is a state machine which is modified by the execution of a series of commands by the client program. The client program sends a stream of commands to render the elements of the scene.

The requirement for generating multiple views is to render the scene multiple times using virtual displaced camera positions. Without the benefit of modifying the source code or, in fact, knowing what the client program will do, the technique is to identify replayable sequences of OpenGL commands using heuristics to identify valid sequences and to optimise the length of the replayable commands. A replayable sequence can be considered a sequence of commands that pass between the application and the API. Essentially the communication stream between the software application and the API is broken down into manageable chunks. The size of these chunks may be relatively arbitrary and depend on the required performance characteristics of the render. The goal of length optimisation is to minimise the number of command flushing stages which occur when a suitable number of commands have been accumulated. The command flushing stage will incur a certain performance overhead or penalty, hence the need to accumulate commands into a buffer before processing.

The command list contains a number of objects defined by a set of 3D geometric primitives. To create a view of these 3D objects it is necessary to define the characteristics of a virtual camera that projects the 3D geometry on to a 2D viewing plane. To generate multiple views multiple virtual cameras are defined each generating a 2D view of the 3D objects. The replayable command list is then used to render multiple views I into OpenGL texture buffers, or, if that capability of the driver is not available, into portions of the final display buffer. To render the multiple views the replayable command sequence may be replayed once for each view. Before each view is generated the perspective transformation matrix can be modified so that each view represents a change in perspective. Thus, over the command stream for the frame, the scene will be gradually drawn for each of the multiple views.

In simplistic terms for example, if a graphics program wishes to draw a circle on the screen, the program will issue a “draw circle” command and the API will undertake the necessary work to have the display driver draw the circle on the screen. In the present invention the program issues the same “draw circle” command. However, the present invention intercepts this command before it reaches the API. If eight views are required the present invention then looks at the “draw circle” command and effectively changes it to “draw eight circles, x and y apart”. This new or modified command is then sent to the API, which through the display driver draws the eight circles on the screen.

In an alternative embodiment, rather than searching for the API function in a number of directories the software application could use an internal symbol table to find the location, in memory, of the API function. The system can then intercept calls to the system library by loading a modified library into memory and redirecting the software application's internal symbol table to refer to modified calls instead of the actual operating system's library.

This process may be illustrated using another example. More specifically we consider the use of the process in converting the computer graphic game ‘Quake’ by ID Software for display on a 4D-Vision model 4D15 autostereoscopic display.

For purposes of explanation it is assumed that the game is running on an IBM compatible PC using the Microsoft Windows 2000 operating system. Since the game uses the OpenGL API then it will call the Windows 2000 OpenGL driver, opengl32.dll, when using a conventional 2D-video display.

Assuming the game is installed in the directory C:\Quake and the system opengl32.dll is found in the directory C:\WINNT\System32.

In order to intercept the OpenGL calls that the game makes to the opengl32.dll driver, a ‘Trojan’ opengl32.dll driver is placed in the same directory as the game executable i.e. C:\Quake.

In general terms an application searches for supporting libraries sequentially in a pre-defined manner using a search path. The search path determines which directories in the computer's file system are searched when locating libraries. A Trojan program placed in a directory that occurs before the system directory in the search path will be located first. Thus when the Quake program is run its program loader will locate this Trojan opengl32.dll before the one located in the system directory. Hence all calls that the games makes to the driver can be intercepted and heuristics used to identify replayable sequences of OpenGL commands.

Once an OpenGL sequence has been identified by the Trojan program they can be altered by rendering multiple views rather than a single view in order to generate the additional data required by the 3D display, and subsequently a new OpenGL command, or set of commands, are created.

The new command(s) are then passed to the system opengl32.dll (which is loaded by the Trojan opengl32.dll) which causes the appropriate image to be displayed on the screen of the 4D15 display.

By way of further example, consider a computer graphic application issuing the command to draw a cube on a 2D screen. For display on an autostereoscopic screen, a number of different ‘viewpoints’ of the cube are required to be drawn. Each viewpoint represents a virtual camera suitably displaced to represent a different eye position. The ‘cube’ is stored in a buffer for rendering. At some point, the Trojan opengl32.dll recognizes that it is necessary to flush the buffer of accumulated graphics primitives.

As it is doing so, it alters the virtual camera viewpoint (as described earlier) and draws the graphics in the storage buffer to the multiple views (which are manifested as auxiliary ‘virtual’ screens—one for each view). The Trojan program generates a 3D image by generating a number of perspective views of the cube in its 3D environment. This is done by altering the position and viewing direction of the virtual camera for each view. As each view is rendered it can be stored in a temporary buffer.

The process continues as the application outputs additional OpenGL commands and drawing primitives.

The majority of computer graphic applications use two drawing buffers. As one buffer is drawn in the background the foreground image is read from the other buffer and displayed on the video monitor. This is known as ‘double-buffering’ and allows smooth transitions between successive video frames.

At the point where the application desires to swap buffers i.e. to present the background buffer for display as the visible image, the Trojan opengl32.dll can then recompose, as exemplified below, the previously rendered multiple views into a single coherent image formatted for display on the 3D monitor.

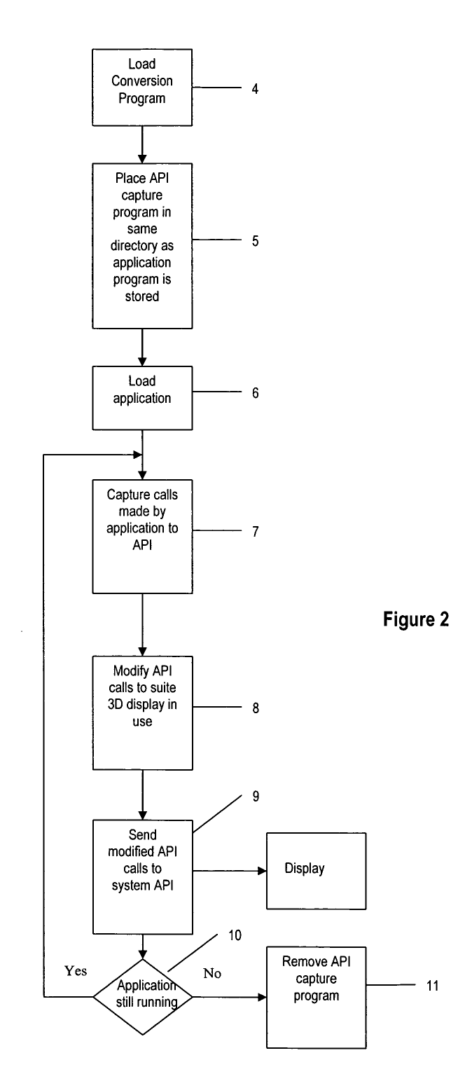

This process is further illustrated in the flow diagram of FIG. 2. At step 4 a program is loaded that initiates the conversion of the computer graphic images to a format suitable for driving a 3D screen. At step 5 an API capture program is placed in the same directory as the target application. At step 6 the application is loaded in the normal way. At step 7 the Trojan program captures calls made by the application to the API. At step 8 the Trojan application makes the necessary modifications to the original calls to suit the display in use. At step 9 the modified calls are sent to the API. At step 10 the process repeats whilst the application is running. At step 11 the Trojan API capture program is removed so that the application may be run using a conventional 2D display if required the next time it is run. Alternatively, it may be desired to leave the Trojan API capture program in place to be used on other applications.

The preferred method of recomposing or combining views with masks to generate composite 3D images may also be used to improve the image quality of multi-view autostereoscopic display systems using slanting optical systems. Such a display is described by van Berkel in U.S. Pat. Nos. 6,118,584 and 6,064,424 and by Grasnik in German patent PCT WO 01/56302 A1.

Whilst van Berkel discloses the use of a slanting lenticular lens and Grasnik the use off a slanting wavelength selective filter it will be appreciated by those skilled in the art that the resulting optical effect, and need for multiple images, is the same.

Both van Berkel and Grasnik disclose the use of multiple views mapped in a specific manner to pixels on a flat panel display device, examples are given using LCD and Plasma displays.

In addition to the disclosure in van Berkel's patents, in a paper “Image Preparation for 3D-LCD” presented at the IS&T/SPIE Conference on Stereoscopic Displays and Applications X, San Jose, Calif., January 1999 van Berkel illustrates the use of a slating lenticular applied to an LCD display to form an autostereoscopic multi-view display.

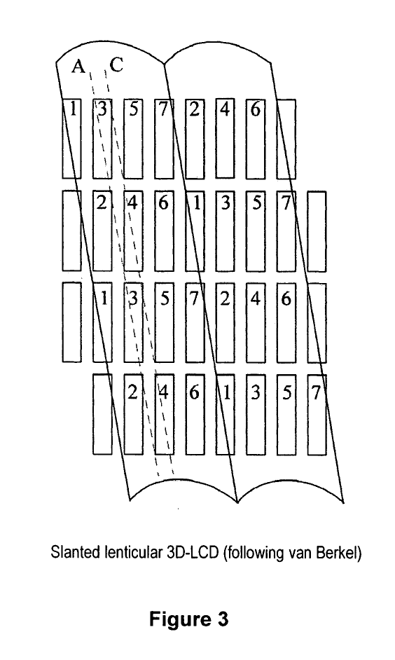

Van Berkel's FIG. 1 from this paper is reproduced as FIG. 3 in this document. This figure shows the mapping of camera views, numbered 1 to 7, to pixels on the underlying LCD display.

For such a display system, either real or virtual cameras could be used to create the seven views and map them to the required pixels. It should be noted that both van Berkel and Grasnik disclose the use of integer views i.e. each pixel is directly mapped to one of N real or virtual cameras.

In van Berkel's SPIE paper he discloses an equation that can be used to calculate the view number N for each pixel k,l which can then be used to assign the appropriate image data to the pixel.

The equation is:

$$N = \frac{( k + {k}_{offset} - 3 l tan α ) mod X}{X} {N}_{tot}$$

where k is horizontal pixel index

k_{offset} is horizontal shift of lenticular lens array

α is angle of lenticular lens array

X is views per lens

Nₜₒₜ is total number of views

and N is the view number of each sub pixel k,l

Van Berkel goes on to teach that for arbitrary values of α and X and finite values of Nₜₒₜ, N will not be an integer. In that case he teaches to take the nearest integer input image to provide the information for a given pixel.

However, it will be appreciated that using the nearest integer approach will in fact result in an inferior image. The effect of using the nearest integer rather than the exact intermediate view is illustrated in the following table:

Nearest Integer View

| | | | | | | | |
|---|---|---|---|---|---|---|---|
| 1 | 3 | 5 | 7 | 2 | 4 | 6 | 1 |
| 7 | 2 | 4 | 6 | 1 | 3 | 5 | 7 |
| 6 | 1 | 3 | 5 | 7 | 2 | 4 | 6 |
| 5 | 7 | 2 | 4 | 6 | 1 | 3 | 5 |

Intermediate View

| | | | | | | | |
|---|---|---|---|---|---|---|---|
| 0.572 | 2.572 | 4.572 | 6.572 | 1.572 | 3.572 | 5.572 | 0.572 |
| 6.568 | 1.568 | 3.568 | 5.568 | 0.568 | 2.568 | 4.568 | 6.568 |
| 5.563 | 0.563 | 2.563 | 4.563 | 6.563 | 1.563 | 3.563 | 5.563 |
| 4.559 | 6.559 | 1.559 | 3.559 | 5.559 | 0.559 | 2.559 | 4.559 |

With Nₜₒₜ=7, X=3.5, α=9.5 and k_{offset}=10.8 (parameters selected to illustrate potential difference between integer and fractional views).

It is appreciated why van Berkel teaches the use of integer views since the use of intermediate views would, in the above example, require 28 intermediate views as opposed to seven integer views.

Such intermediate views could be created using real or virtual cameras. In the former this is considered impractical and in the latter the overhead of rending 28 views would place a significant load on the computer and potentially adversely effect the response time and thus also considered impractical.

It will also be appreciated by those skilled in the art that the exact fractional views are dependant on the value of a and will therefore most likely vary between different screens. Hence, in practice, it is desirable to provide a solution that enables the exact intermediate views to be generated to match the optical characteristics of a particular display.

As explained above, for computer graphic applications, the prior art teaches to create intermediate views by positioning virtual cameras and rendering all the necessary views. Whilst this would produce the desired multi-view image it does place a significant additional load on the computer. In particular where the computer is being used to play a game such an additional processing load may slow the computer so as to adversely affect the game-play.

It is therefore desirable to provide a generic solution to the problem of providing the exact intermediate views with minimal computational overheads. The present invention teaches this by generating a number of equally spaced i.e. integer views, for example purposes only we will use seven views, and produce the exact intermediate views using synthesis techniques.

In a preferred embodiment generation of intermediate views includes two steps. The first is to calculate modulation mask textures that are used to represent the fractional proportion of each actual view for each pixel (red, green and blue) component. Thus there is one mask for each exact view.

An example of a proportion may be that the red component of a particular pixel is best approximated by 30% of view 3 and 70% of view 4. The masks are generated specifically to suit the particular optical characteristics of the display in use.

The mask values are calculated using the characteristics of the screen. Essentially it is necessary to calculate two variables, the number of views per colour component V_{c} and the number views per image row, Vᵣ.

$${V}_{c} = \frac{\frac{{N}_{tot}}{3}}{{P}_{μ}}$$

$${V}_{r} = \frac{{N}_{tot} tan ( α )}{{P}_{μ}}$$

Where P_{μ} is the horizontal component of the lenticular pitch and is derived from:

P_{μ}=P\sqrt{1+tan(α)²}

where P is the lenticular pitch and α is the angle of the lenticular lens and Nₜₒₜ is the total number of distinct views.

To form a composite 3D image for a lenticular LCD the image is traversed in a raster scan. For the first position in the raster scan the view is initialised to an arbitrary view number. For each subsequent red, green or blue colour component in the same row of the raster scan the previous view is incremented by the value of V_{c}. As V_{c} may be a fractional value (for example, 2.63) the view calculated is fractional. Similarly, as the raster scan advances to a new row the view is incremented by Vᵣ.

The determination of the modulation mask value from the fractional view is a simple weighted average of the closest 2 views. For any given fractional view V_{f} the mask values can be calculated using the following procedure:

1. Set all masks to zero.

2. mask(floor(V_{f}))=ceil(V_{f})−V_{f}

3. mask(ceil(V_{f}))=Vᵣfloor(V_{f})

For example, if we have a fractional view V_{f}=3.8 then for that specific pixel mask(3)=0.2 and mask(4)=0.8 and all other masks are equal to zero.

The sum of all proportions for all masks for an individual pixel component will be 100%.

The second step of intermediate view generation is to compose all rendered exact views to generate the final image for display. This is done by applying a simple summation function for each pixel component (red, green ,blue) as follows:

$$value = {\sum }_{i = 1}^{{N}_{tot}} view ( i ) mask ( i )$$

Practically, this is implemented using a texture cascade where the first texture stage is the exact view and the second texture stage the mask view. Then, a modulation operator is specified for the textures. A rectangle is drawn the size of the screen with textures indexed appropriately.

The frame buffer is set to accumulate (after being initially cleared) and all views iterated with their corresponding masks using the modulation procedure. Thus, this achieves the required summation function as described above.

Whilst the method and apparatus of the present invention has been summarised and explained by illustrative application it will be appreciated by those skilled in the art that many widely varying embodiments and applications are within the teaching and scope of the present invention, and that the examples presented herein are by way of illustration only and should not be construed as limiting the scope of this invention.

1. A method of generating images suitable for use with a multi-view stereoscopic display including the steps of:
intercepting data passed from an application to an application programming interface, said data representing a scene or object to be displayed on said display, and wherein said data is intercepted by looking up an internal symbol table to determine a memory location for an application programme interface function, storing a modified library into memory, and redirecting application commands to said memory location to said modified library;
processing said data to render multiple views of said scene or object;
creating modified data by modifying said intercepted data to represent said multiple views;
passing said modified data to said application programming interface.

2. A method as claimed in claim 1 wherein processing of said data includes the steps of:
identifying replayable sequences of commands and processing said commands with valid sequences to minimize command flushing stages required.

3. A method as claimed in claim 1 wherein said multiple views are composed into a composite image

4. A method as claimed in claim 3 wherein said composite image is formed by mapping said multiple views to pixels on said display by:
$$N = \frac{( k + {k}_{offset} - 3 l tan α ) mod X}{X} {N}_{tot}$$
where k is a horizontal pixel index
k_{offset} is horizontal shift of lenticular lens array
α is angle of the lenticular lens array
X is views per lens
Nₜₒₜ is total number of views
and N is view number of each sub pixel k,l

5. A method as claimed in claim 4 wherein N is rounded to a nearest integer value.

6. A method as claimed in claim 4 wherein image data for each pixel is determined by a weighted average of views having closest integer values to N.

7. A method as claimed in claim 4 further including the step of generating a modulation mask based on characteristics of said display, wherein
$${V}_{c} = \frac{\frac{{N}_{tot}}{3}}{{P}_{μ}}$$
$${V}_{r} = \frac{{N}_{tot} tan ( α )}{{P}_{μ}}$$
where horizontal component of lenticular pitch is P_{μ} and is derived from:
P_{μ}=P\sqrt{1+tan(α)²}
where P is the lenticular pitch and α is angle of the lenticular lens and Nₜₒₜ is total number of distinct views;
and wherein for each colour component of a row of a raster scan a previous view is incremented by V_{c}, and for each row the view is incremented by Vᵣ.

8. A system for creating images suitable for use with a multi-view autostereoscopic display including:
a capture means for intercepting 3D geometric primitives and associated characteristics passed between an application and an application programming interface;
a view generation means for imaging said 3D geometric primitives and said associated characteristics from multiple distinct viewing positions;
a mask calculation means for determining a relative contribution of each view based on characteristics of an associated lenticular lens array; and an accumulation means for combining said views with said masks to generate a composite 3D image.

9. A system as claimed in claim 8 wherein said capture means intercepts said primitives an characteristics by:
looking up an internal symbol table to determine a memory location for an application programme interface function;
storing a modified library into memory; and
redirecting application commands to said memory location to said modified library.

10. A system as claimed in claim 8 wherein said accumulation means includes:
a view calculator to determine which said view is assigned to each pixel of said 3D image.

11. A system as claimed in claim 10 wherein said view calculator determines said view by:
$$N = \frac{( k + {k}_{offset} - 3 l tan α ) mod X}{X} {N}_{tot}$$
where k is a horizontal pixel index
k_{offset} is horizontal shift of lenticular lens array
α is angle of the lenticular lens array
X is views per lens
Nₜₒₜ is total number of views
and N is view number of each sub pixel k,l

12. A system as claimed in claim 8 wherein said mask calculation means determines a fractional proportion of each said view for each pixel of said 3D image.

13. A system as claimed in claim 8 wherein characteristics of said lens array are determined by:
$${V}_{c} = \frac{\frac{{N}_{tot}}{3}}{{P}_{μ}}$$
$${V}_{r} = \frac{{N}_{tot} tan ( α )}{{P}_{μ}}$$
where horizontal component of lenticular pitch is P_{μ} and is derived from:
P_{μ}=P\sqrt{1+tan(α)²}
where P is the lenticular pitch and α is angle of the lenticular lens and Nₜₒₜ is total number of distinct views;
and where V_{c} represents the number of views per colour component and Vᵣ represents the number of views per image row.

14. A system as claimed in claim 13 wherein said 3D image is traversed in a raster scan to form said composite image.

15. A system as claimed in claim 14 wherein a first position of said raster scan is initialized to an arbitrary view number.

16. A system as claimed in claim 15 wherein for each subsequent colour component in a same row of said raster scan a previous view is incremented by V_{c}.

17. A system as claimed in claim 16 wherein as said raster scan advances to a new row the view is incremented by Vᵣ.
